(19) United States
(12) Patent Application Publication
(10) Pub. No.: US 2022/0010593 A1
(43) Pub. Date: Jan. 13, 2022

(54) CAM ASSISTED HANDLE SYSTEM

(71) Applicant: Arconic Technologies LLC, Pittsburgh, PA (US)

(72) Inventors: Kyle A. McDaniel, Johns Creek, GA (US); Andrew C. Agliata, East Northport, NY (US); Scott J. Bowden, Bishop, GA (US); Katherine C. Freeseman, Savannah, GA (US); David C. Johnston, Suwanee, GA (US); John Michael Mitchell, Oakton, VA (US); Clare K. Specht, Silver Spring, MD (US)

(73) Assignee: Arconic Technologies LLC, Pittsburgh, PA (US)

(21) Appl. No.: 17/295,155

(22) PCT Filed: Nov. 25, 2019
(86) PCT No.: PCT/US2019/063045

§ 371 Date: May 19, 2021

Related U.S. Application Data
(60) Provisional application No. 62/771,764, filed on Nov. 27, 2018.

(51) Int. Cl. E05B 17/00; E05F 11/54; E05B 1/00

(52) U.S. Cl. CPC E05B 17/0033; E05F 11/54; E05B 1/0015; E05Y 2900/132; E05B 1/0053; E05Y 2201/638; E05B 1/003

(57) ABSTRACT

A sliding door system includes a stationary door frame, a sliding door panel installed in the stationary door frame and movable between closed and open positions, and a handle assembly coupled to the sliding door panel. The handle assembly includes a handle spindle extending into a vertical stile of the sliding door panel, a cam coupled to the handle spindle within the vertical stile and movable between stowed and extended positions, and a handle coupled to the handle spindle and rotatable about a pivot axis extending through the handle spindle between first and second positions. Rotating the handle from the first position to the second position causes the cam to move from the stowed position to the extended position and into engagement with the stationary door frame, whereby the sliding door frame is forced away from the stationary door frame from the closed position to the open position.

### BACKGROUND

Opening and moving sliding glass doors is oftentimes difficult, especially for the elderly and individuals suffering from mobility issues. The difficulty can be amplified with sliding glass doors installed in high-rise buildings and beach properties, where there is a high-pressure differential between the exterior and interior of the building.

The 2010 Americans with Disabilities Act (ADA) Standards for Accessible Design specifies a 5 lb. maximum limit of user input force to operate sliding glass doors. The ADA standards also mandate that tight gripping and twisting of the wrist not be required to operate the handle. If a user has rheumatoid arthritis, for example, inflammation of joints may make twisting motion of the door painful or even impossible.

With a growing portion of the population being elderly people or people with mobility issues, it is desired to develop a technology to assist with opening heavy sliding glass doors.

### SUMMARY OF THE DISCLOSURE

Embodiments disclosed herein include a sliding door system that includes a stationary door frame, a sliding door panel installed in the stationary door frame and movable between a closed position and an open position, and a handle assembly coupled to the sliding door panel. The handle assembly may include a handle spindle extending into a vertical stile of the sliding door panel, a cam coupled to the handle spindle within the vertical stile and movable between a stowed position and an extended position, and a handle coupled to the handle spindle and rotatable about a pivot axis extending through the handle spindle between a first position and a second position. Rotating the handle from the first position to the second position may cause the cam to move from the stowed position to the extended position and into engagement with the stationary door frame, whereby the sliding door frame is forced away from the stationary door frame from the closed position to the open position. In a further embodiment, the sliding door system may further include a weathered pocket provided on a side member of the stationary door frame, the vertical stile being partially receivable within the weathered pocket when the sliding door panel is in the closed position, and wherein moving the cam to the extended position engages the cam on the side member and thereby disengages the vertical stile from the weathered pocket. In another further embodiment of any of the previous embodiments, 5 lbs. of force or less is required to be applied to the handle to disengage the vertical stile from the weathered pocket. In another further embodiment of any of the previous embodiments, the handle in the first position is oriented at an angle between horizontal and vertical. In another further embodiment of any of the previous embodiments, the handle has an arcuate body. In another further embodiment of any of the previous embodiments, the sliding door system further includes an upwardly-protruding lip provided at a distal end of the handle. In another further embodiment of any of the previous embodiments, the handle assembly is made of a rigid material selected from the group consisting of a metal, a high-strength polymer, a composite material, glass, and any combination thereof. In another further embodiment of any of the previous embodiments, the handle spindle is supported by one or more low-friction bearings. In another further embodiment of any of the previous embodiments, the sliding door system further includes a helical coil spring operatively coupled to the handle spindle and operable to move the handle back to the first position when a user input force is removed from the handle. In another further embodiment of any of the previous embodiments, the handle comprises a first handle mounted on a first side of the vertical stile and coupled to a first end of the handle spindle, the handle assembly further including a second handle mounted on a second side of the vertical stile and coupled to a second end of the handle spindle, the second handle being rotatable about the pivot axis between a first position and a second position, wherein rotating the second handle from the first position to the second position causes the cam to move from the stowed position to the extended position.

Embodiments disclosed herein may further include a method of operating a sliding door system that includes placing a load on a handle of handle assembly coupled to a sliding door panel installed in a stationary door frame, the handle assembly including a handle spindle extending into a vertical stile of the sliding door panel, the handle being coupled to the handle spindle, and a cam coupled to the handle spindle within the vertical stile and movable between a stowed position and an extended position. The method may further include pivoting the handle about a pivot axis extending through the handle spindle from a first position to a second position and thereby moving the cam to the extended position and into engagement with the stationary door frame, and forcing the sliding door frame away from the stationary door frame with the cam and thereby moving the sliding door frame from the closed position to the open position. In a further embodiment, the weathered pocket is provided on a side member of the stationary door frame, the method may further include partially receiving the vertical stile within the weathered pocket when the sliding door panel is in the closed position, rotating the cam toward the extended position and thereby engaging the cam on the side member, and disengaging the vertical stile from the weathered pocket as the cam moves to the extended position. In a further embodiment, the method may include applying no more than 5 lbs. of force to the handle to disengage the vertical stile from the weathered pocket. In a further embodiment, the handle spindle is supported by one or more low-friction bearings, and a helical coil spring is operatively coupled to the handle spindle, the method may further include building spring force in the helical coil spring as the handle moves from the first position to the second position, removing the load on the handle, releasing the spring force in the helical coil spring and thereby moving the handle from the second position to the first position, and moving the cam back to the stowed position as the handle moves from the second position to the first position. In a further embodiment, the handle comprises a first handle mounted on a first side of the vertical stile and coupled to a first end of the handle spindle, the handle assembly further including a second handle mounted on a second side of the vertical stile and coupled to a second end of the handle spindle, the method further including pivoting the second handle about the a pivot axis between a first position and a second position and thereby moving the cam to the extended position and into engagement with the stationary door frame, and forcing the sliding door frame away from the stationary door frame with the cam and thereby moving the sliding door frame from the closed position to the open position.

Embodiments disclosed herein may further include a handle assembly for a sliding door panel of a sliding door system, the handle assembly including a handle spindle extendable into a vertical stile of the sliding door panel, a cam coupled to the handle spindle and configured to be positioned within the vertical stile and movable between a stowed position and an extended position, and a handle coupled to the handle spindle and rotatable about a pivot axis extending through the handle spindle between a first position and a second position, wherein rotating the handle from the first position to the second position causes the cam to move from the stowed position to the extended position and protrude from the vertical stile. In a further embodiment, the handle in the first position is oriented at an angle between horizontal and vertical. In a further embodiment, the handle has an arcuate body and an upwardly-protruding lip provided at a distal end of the handle. In a further embodiment, the handle assembly further includes a roller element rotatably mounted to the cam. In a further embodiment, the handle assembly further includes at least one of one or more low-friction bearings that supports the handle spindle, and a helical coil spring operatively coupled to the handle spindle and operable to move the handle back to the first position when a user input force is removed from the handle.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIGS. 1A and 1B are front views of an example sliding door system, according to one or more embodiments.

FIGS. 2A and 2B are right and left isometric views, respectively, of a portion of the system of FIGS. 1A-1B.

FIGS. 3A and 3B are right and left isometric views, respectively, of the handle assembly of FIGS. 1A-1B and 2A-2B, according to one or more embodiments.

FIGS. 5A and 5B are schematic views of an example cam that may be used in accordance with the principles of the present disclosure.

FIG. 6 provides a free body diagram graphically depicting example calculation of the cam dimensions.

FIG. 7 is a plot showing example moment arm (rₓ) as a function of angle of rotation for varying values of r_{cam} for an example cam.

FIG. 8 is a plot showing example moment arm (r_{y}) as a function of angle of rotation for varying values of r_{cam} for an example cam.

FIGS. 9A and 9B are plots of a 0.3 inch radius cam and a 1.2 inch radius cam, respectively, at their maximum value of r_{y}.

FIG. 10 is a plot depicting the torque required vs. cam angle for varying friction coefficients.

FIG. 11A is a right isometric view of a portion of the system of FIGS. 1A-1B, according to one or more additional embodiments.

FIG. 11B is an enlarged isometric view of the cam of FIG. 11A, according to one or more embodiments.

### DETAILED DESCRIPTION

The present disclosure is related to sliding glass doors and, more particularly, to handle assemblies for sliding glass doors that provide a mechanical advantage.

Embodiments discussed herein describe technology developed to assist with opening heavy sliding glass doors. The 2010 Americans with Disabilities Act (ADA) Standards for Accessible Design specifies a 5 lb. maximum limit of user input force to operate sliding glass doors. The present disclosure describes mechanically advantaged handle assemblies for sliding glass doors that comply with ADA standards. The handle assemblies described herein are developed for use in existing sliding door products and provide a mechanical advantage that multiplies the user input force necessary to disengage the door from the frame and rolling force. Consequently, existing sliding door products can be retrofitted with the presently disclosed handle assemblies to make the sliding door product ADA compliant. Alternatively, the handle assemblies described herein may be installed in new sliding door products to achieve ADA compliance.

Moreover, the presently disclosed handle assemblies do not impede the ability of existing sliding glass doors to pass hurricane safety tests. Some doors are rated to sustain a Category 5 hurricane, which is defined by the National Hurricane Center as exacting catastrophic damage with 157 mph winds (approximately 13,600 lbf.), total roof failure, and wall collapse. The presently disclosed handle assemblies may be incorporated into and otherwise modify existing sliding glass doors rated to withstand Category V hurricane forces without compromising this rating. Accordingly, the handle assemblies described herein do not diminish the ability of an existing sliding glass door to resist hurricane forces.

One example sliding door system disclosed herein includes a stationary door frame, a sliding door panel installed in the stationary door frame and movable between a closed and open position, and a handle assembly coupled to the sliding door panel. The handle assembly can include a handle spindle extending into a vertical stile of the sliding door panel, a cam coupled to the handle spindle within the vertical stile and movable between stowed and extended positions, and a handle coupled to the handle spindle and rotatable about a pivot axis extending through the handle spindle between first and second positions. Rotating the handle from the first position to the second position causes the cam to move from the stowed position to the extended position and into engagement with the stationary door frame, whereby the sliding door frame is forced away from the stationary door frame from the closed position to the open position. Moreover, rotating the handle may be designed with the ergonomic intention of user intuitiveness due to the ability for the user to disengage the door with a mechanical advantage obtained via the handle assembly described herein, and subsequently apply the rolling force to continue the opening process with one continuous motion.

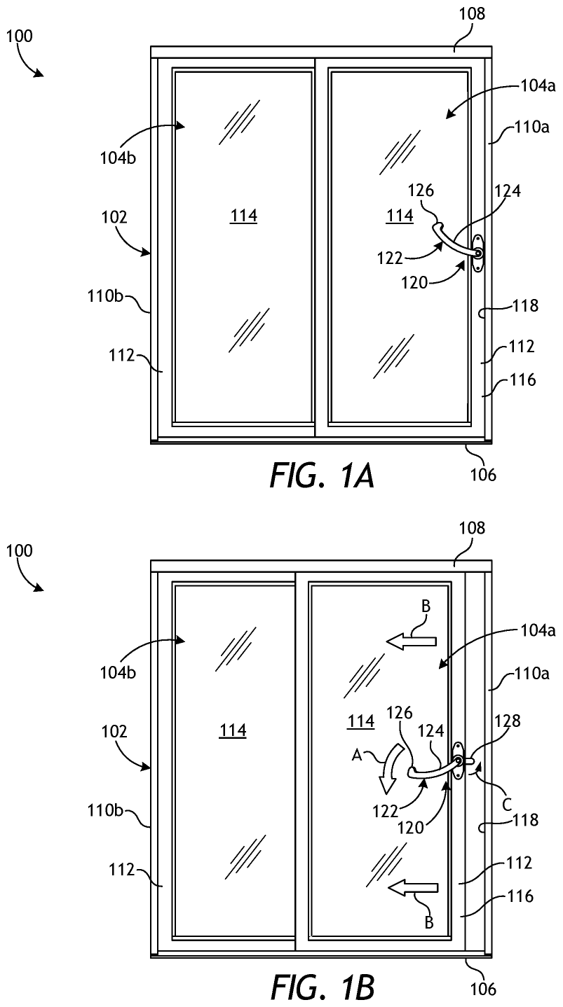

FIGS. 1A and 1B are front views of an example sliding door system 100, according to one or more embodiments. More specifically, FIG. 1A shows the sliding door system 100 (hereafter the “system 100”) in a closed position (alternately referred to as the “sealed” position), and FIG. 1B shows the system 100 in an open position (alternately referred to as the “sliding” or “rolling” position). While the following description is directed to sliding door systems, the principles of the present disclosure are equally applicable to sliding window systems or assemblies.

As illustrated, the system 100 includes a door frame 102 that supports a sliding door panel 104a and a stationary door panel 104b. The door frame 102 includes a bottom member 106, a top member 108, and opposing first and second side members 110a and 110b that extend between the bottom and top members 106, 108. The door frame 102 may be installed in any residential or commercial building, and the sliding and stationary door panels 104a,b may be installed in the door frame 102 to separate the outside (exterior) environment from the inside (interior) environment.

The sliding door panel 104a is designed to move (e.g., slide, roll, translate, etc.) relative to the door frame 102 and the stationary door panel 104b, which remain static. The sliding and stationary door panels 104a,b may each include a frame 112 that surrounds a window pane 114. The window panes 114 may each comprise one or more panes of window glass, one or more panes of polycarbonate, or one or more panels of material that are clear, translucent, tinted, or opaque. Those skilled in the art will readily appreciate that other general designs and/or configurations for the sliding and stationary door panels 104a,b may alternatively be employed in the system 100, without departing from the scope of the disclosure.

When in the closed position, the sliding door panel 104a may be substantially sealed about its periphery such that the migration (leakage) of air, water, and/or debris about the perimeter of the frame 112 is largely prevented. Moreover, in the closed position, a portion of a vertical stile 116 of the frame 112 of the sliding door panel 104a may be partially received within a vertical weathered pocket 118 defined by the first side member 110a. The weathered pocket 118 may have a depth of about 0.5 inches to about 1.0 inches to receive the adjacent vertical stile 116 of the frame 112. In some embodiments, one or more gaskets or seals, sometimes referred to as “weathering piles,” may be arranged within the weathered pocket 118 to seal against the vertical stile 116 protruding into the weathered pocket 118. As used herein, moving the sliding door panel 104a from the closed position to the open position refers to disengaging the vertical stile 116 from the vertical weathered pocket 118. Moreover, moving the sliding door panel 104a to the “fully open” position refers to sliding or rolling the sliding door panel 104a away from the first side member 110a to its fullest extent.

To help transition the sliding door panel 104a between the closed and open (sliding) positions, the system 100 includes a handle assembly 120, which includes a handle 122 that is manually articulable between a first or “resting” position, as shown in FIG. 1A, and a second or “actuated” position, as shown in FIG. 1B. In some embodiments, as illustrated, the handle 122 may have a body 124 that is generally arcuate (curved), and may terminate at an upwardly-protruding lip 126.

In some embodiments, the handle 122 in the first position may be oriented upwardly and otherwise at any angle above horizontal and below vertical. For example, the angle of the handle 122 in the first position may range between about 20° and about 70°, between about 30° and about 60°, or between about 40° and about 50°, or any angular subset thereof.

The curvature and orientation of the handle 122 in the first position may prove advantageous for users with limited mobility since it minimizes the need to grip the handle 122 or twist the wrist when moving the handle 122 to the second position. Instead, a user may place their hand or other body part (e.g., a forearm, a wrist, etc.) onto the handle 122 in the first position and generally push downward to rotate the handle 122 about its pivot axis, as indicated by the arrow A in FIG. 1B. In some cases, the user may merely rest their hand or other body part on the handle 122 and push downward to move the handle 122 to the second position.

Moreover, the curvature of the handle 122 and the upwardly-protruding lip 126 may help ease sliding (rolling) the sliding door panel 104a to the fully open position. More specifically, when the handle 122 is in the second position, as shown in FIG. 1B, one or both of the body 124 of the handle 122 and the upwardly-protruding lip 126 may be oriented at a position between horizontal and vertical. As a result, the user need only push on the handle 122 in the direction indicated by the arrows B to move the sliding door panel 104a to the fully open position. This is in contrast to conventional sliding glass door handles, which commonly require users to tightly grasp the handle and pull the sliding door to the fully open position.

While the body 124 of the handle 122 is depicted in FIGS. 1A-1B as generally arcuate (curved), the body 124 may alternatively be substantially straight as it extends from the pivot axis of the handle 122. In such embodiments, the upwardly-protruding lip 126 may be oriented at a position between horizontal and vertical when the handle 122 is in the second position and thereby provide a location where the user can engage and push in the direction B to move the sliding door panel 104a to the fully open position.

As discussed above, the Americans with Disabilities Act (ADA) specifies a 5 lb. maximum limit of user input force to operate (i.e., open and roll) a sliding glass door, such as the sliding door panel 104a. Because of its weight and sealed engagement about its periphery and especially within the weathered pocket 118, moving the sliding door panel 104a from the closed position to the open position (i.e., disengaging the vertical stile 116 from the vertical weathered pocket 118) can require over 12 lbs. of user input force. According to embodiments of the present disclosure, however, the design and configuration of the handle assembly 120 provides a mechanical advantage that multiplies the user input force when moving the handle 122 from the first position to the second position to a level sufficient to disengage the sliding door panel 104a from the weathered pocket 118 within ADA limits. In some embodiments, for example, the handle assembly 120 is capable of providing a mechanical advantage that converts about 5 lbs. of user input force to 12 lbs. or more of force, which is enough to disengage the sliding door panel 104a from the weathered pocket 118, thus making the system 100 ADA compliant and easier for a user to move the sliding door panel 104a from the closed position to the open position.

As described in more detail below, moving the handle 122 to the second position helps transition the sliding door panel 104a from the closed position to the open position and, more particularly, helps disengage the vertical stile 116 from the weathered pocket 118. As shown in FIG. 1B, the handle assembly 120 may include an internal cam 128 that is stowed within the stile 116 when the handle 122 is in the first position. When the handle 122 is rotated from the first position to the second position, however, the cam 128 is correspondingly rotated toward an extended position, as indicated by the arrow C, and into progressive lateral engagement with the first side member 110a. More specifically, upon moving the handle 122 to the second position, the cam 128 is simultaneously rotated partially out of the vertical stile 116 in the direction C to bear against the laterally adjacent first side member 110a. The cam 128 applies a disengagement force against the first side member 110a as it rotates in the direction C and thereby drives the sliding door panel 104a away from the first side member 110a and to the open position. Once in the open position, only about 5 lbs. of user input force is needed to continue moving (rolling) the sliding door panel 104a to a fully open position.

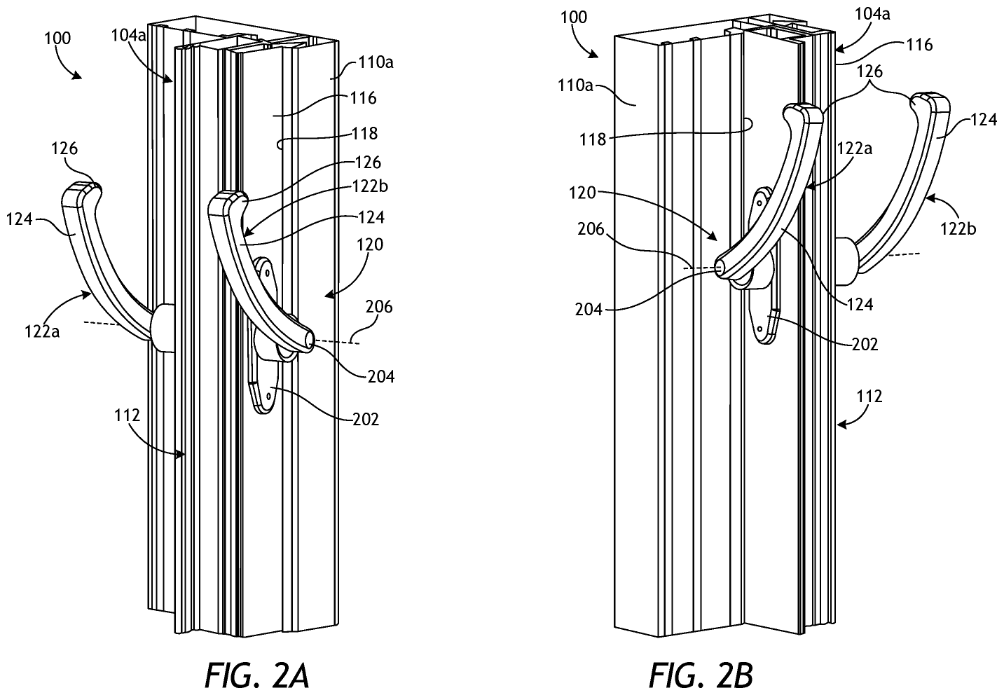

FIGS. 2A and 2B are right and left isometric views, respectively, of a portion of the system 100 of FIGS. 1A-1B. More specifically, FIGS. 2A and 2B depict right and left isometric views, respectively, of the handle assembly 120 as installed in the vertical stile 116 of the frame 112 of the sliding door panel 104a. The window pane 114 (FIG. 1) is omitted in FIGS. 2A-2B for convenience and ease of viewing. The sliding door panel 104a is depicted in the closed position with a portion of the vertical stile 116 received within the vertical weathered pocket 118 defined by the first side member 110a.

In the illustrated embodiment, the handle assembly 120 includes a first or “interior” handle 122a and a second or “exterior” handle 122b. In other embodiments, however, the handle assembly 120 may include only one of the first or second handles 122a,b, without departing from the scope of the disclosure. Each handle 122a,b is arranged on an opposing side of the stile 116 at a corresponding escutcheon or “trim” plate 202 secured to each side of the stile 116. The first handle 122a is mounted to the stile 116 on the interior side of the sliding door panel 104a at one trim plate 202, and the second handle 122b is mounted to the stile 116 on the exterior side of the sliding door panel 104a at a second trim plate 202.

In the illustrated embodiment, the handles 122a,b may each be mounted to a common handle rod or “spindle” 204 that extends through the stile 116 and the trim plates 202. In at least one embodiment, the handles 122a,b may be coupled to opposing ends of the handle spindle 204. In embodiments with only one handle 122a,b, the single handle 122a,b may be mounted to the handle spindle 204 on one side of the stile 116. The handles 122a,b each rotate about a pivot axis 206 that extends through the handle spindle 204. The body 124 may be coupled to the handle spindle 204 and extend therefrom in a generally arcuate (curved) direction (or alternatively straight). As indicated above, the body 124 may also terminate at the upwardly-protruding lip 126.

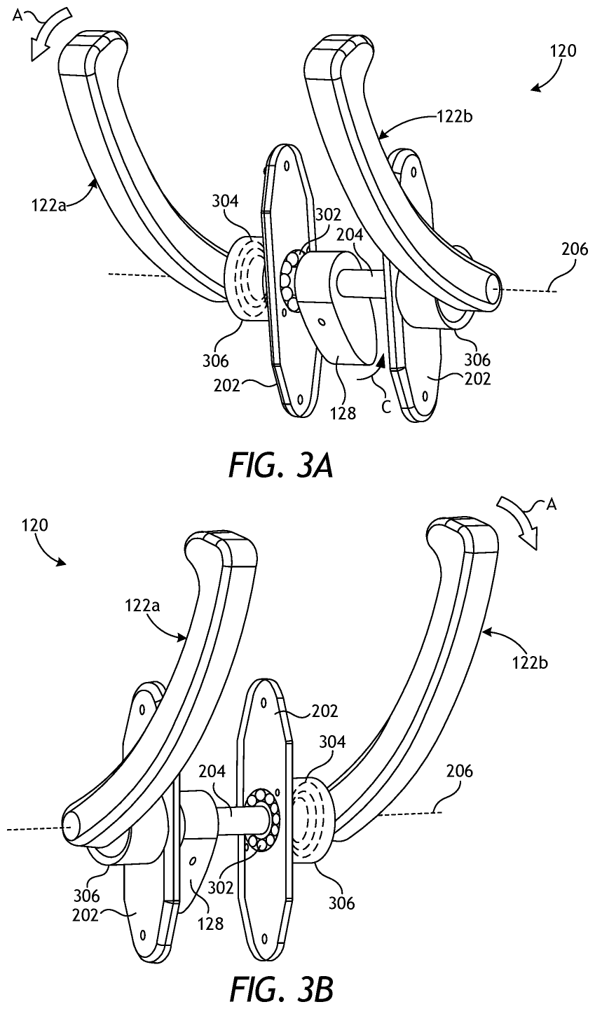

FIGS. 3A and 3B are right and left isometric views, respectively, of the handle assembly 120 of FIGS. 1A-1B and 2A-2B, according to one or more embodiments of the disclosure. As illustrated, the handles 122a,b are each coupled to the handle spindle 204, which is rotatable about the pivot axis 206. In some embodiments, each handle 122a,b is fixed to the handle spindle 204 such that rotation of one handle 122a,b about the pivot axis 206 correspondingly rotates the other handle 122a,b in the same direction. In at least one embodiment, however, the handles 122a,b may be configured to rotate independent of each other, without departing from the scope of the disclosure.

The cam 128 may be coupled to the handle spindle 204 such that rotation of the handle spindle 204 by rotating one or both of the handles 122a,b correspondingly rotates the cam 128 in the same angular direction. Accordingly, rotating one or both of the handles 122a,b from the first position to the second position in the direction A correspondingly rotates the cam 128 from the stowed position to the extended position in the direction C (FIG. 3A). In some embodiments, the cam 128 may be coupled to the handle spindle 204 and secured in place using one or more mechanical fasteners, an adhesive, a welded interface, an interference fit, or any combination thereof. In other embodiments, however, the cam 128 may be secured by a key into one or more keyway defined in one or both of the cam 128 or the handle spindle 204. In yet other embodiment, the cam 128 may form an integral part or feature of the handle spindle 204, without departing from the scope of the disclosure. In at least one embodiment, instead of the cam 128 being coupled to or forming an integral part of the handle spindle 204, it is contemplated herein that the cam 128 may form an integral part of a lock mechanism (not shown) included in the system 100.

Various parts of the handle assembly 120, such as the handles 122a,b, the cam 128, and the handle spindle 204 may be made of a variety of rigid materials including, but not limited to, a metal, a high-strength polymer, a composite material, glass, or any combination thereof. These parts may be manufactured via a variety of known manufacturing processes including, but not limited to, injection molding, casting, machining, extruding, additive manufacturing (i.e., 3D printing), or any combination thereof.

In some embodiments, the handle spindle 204 may be supported by one or more low-friction bearings 302, such a ball bearings, needle bearings, or the like. In the illustrated embodiment, a corresponding bearing 302 interposes each handle 122a,b and the associated trim plate 202. In other embodiments, however, the bearings 302 may be located internal to the stile 116 (FIGS. 1A-1B and 2A-2B), without departing from the scope of the disclosure.

In one or more embodiments, one or both of the handles 122a,b 302 may be spring loaded. More specifically, a helical coil spring 304 (shown in dashed) may be arranged within a spring housing 306 and operatively coupled to the handle spindle 204 at the adjacent trim plate 202. As the handles 122a,b move in the direction A from the first position to the second position, spring force builds within the helical coil spring 304. Once the user input force on the handles 122a,b is removed, the built up spring force is able to release and causes the handles 122a,b to automatically rotate in the opposite direction and back toward the first position. As will be appreciated, this also correspondingly retracts the cam 128 back to the stowed position.

FIGS. 4A-4C depict corresponding side and partial cross-sectional top views of the handle assembly 120 during example operation, according to one or more embodiments. More specifically, each of FIGS. 4A-4C include a bottom image, which corresponds to the side view of the handle assembly, and a top image, which corresponds to the partial cross-sectional top view of the handle assembly 120 as taken along the line indicated in the corresponding bottom image. Moreover, FIGS. 4A-4C show progressive movement of the handles 122a,b pivoting from the first position, as shown in FIG. 4A, to the second position, as shown in FIG. 4C, and thereby moving the sliding door panel 104a from the closed position to the open position.

In FIG. 4A, the vertical stile 116 is partially received within the vertical weathered pocket 118 defined by the first side member 110a. While not shown, one or more gaskets, seals, or “weathering piles” may be arranged within the weathered pocket 118 to seal against the vertical stile 116 protruding into the weathered pocket 118. Moreover, as depicted in the top image of FIG. 4A, the cam 128 is in the stowed position and, therefore, does not protrude from the vertical stile.

As depicted in the bottom image of FIG. 4A, the handle 122 in the first position may be generally oriented upwardly and otherwise at an angle 402 between horizontal and vertical. In the illustrated embodiment, the angle is about 30°, but may range between about 20° and about 70°, without departing from the scope of the disclosure.

In FIG. 4B, the handles 122a,b are rotated slightly in the direction A about the pivot axis 206 from the first position and toward the second position. Rotating the handles 122a,b in the direction A correspondingly causes the handle spindle 204 to rotate in the same direction. Moreover, as depicted in the top image of FIG. 4B, as the first handle 122a rotates toward the second position, the cam 128 correspondingly rotates from the stowed position toward the extended position and starts protruding from stile 116 to engage the inner surface of the weathered pocket 118.

In FIG. 4C, the handles 122a,b are rotated more fully in the direction A and to the second position, which correspondingly causes the handle spindle 204 to rotate in the same direction. Moreover, as depicted in the top image of FIG. 4C, as the handles 122a,b reach the second position, the cam 128 correspondingly rotates and reaches the extended position. As the cam 128 rotates to the extended position, the rounded outer surface of the cam 128 progressively engages and bears against the inner surface of the weathered pocket 118. In its rotation, the cam 128 applies a camming force against the first side member 110a that disengages the stile 116 from the weathered pocket 118 and drives the sliding door panel 104a away from the first side member 110a and to the open position in the direction indicated by the arrows B.

In the embodiments described herein, the handles 122a,b do not require that a user tightly grip the handles 122a,b or twist the wrist to operate the handles 122a,b. Rather, a simple user input force as indicated by the arrows A need only be applied. Once the sliding door panel 104a is disengaged from the weathered pocket 118, a user may continue to apply a generally lateral force on the handle(s) 122a,b to move (e.g., roll, slide, etc.) the sliding door panel 104a to the fully open position. In some cases, for example, when the handle(s) 122a,b is/are in the second position, the upwardly-protruding lip 126 may provide an angled surface on which the user can apply a lateral force to push the sliding door panel 104a to the fully open position. As noted above, this is in contrast to conventional sliding glass door handles, which commonly require users to tightly grasp the handle and pull the sliding door to the fully open position.

Still referring to FIG. 4C, the length of the handle(s) 122a,b (e.g., the body 124 of the handle 122a,b) and the cam 128 each provide the handle assembly 120 with a mechanical advantage that amplifies a user input force and makes the system 100 (FIGS. 1A-1B) ADA compliant. As will be appreciated, the length of the handle(s) 122a,b from the pivot axis 206 to its tip may comprise a large factor in how much mechanical advantage is gained. In some embodiments, for example, the length of the handle(s) 122a,b from the handle spindle 204 to the distal tip may be about 6 inches, which may stay in keeping with aesthetics of the door and to ensure that the handle 122a,b can be installed within existing dimensions of existing doors. Moreover, once the sliding door panel 104a is moved to the fully open position, the handle(s) 122a,b will not restrict any part of the doorway. The length of the handle(s) 122a,b, however, can be longer or shorter than 6 inches, without departing from the scope of the disclosure, and may be designed to fit particular door applications.

The curvature, lift, and duration of the cam 128 may also play a factor in how much mechanical advantage is gained. In some embodiments, the combination of the length of the handle(s) 122a,b and the design of the cam 128 can provide a mechanical advantage that converts about 5 lbs. of user input force to 12 lbs. or more of force, which is enough to disengage the sliding door panel 104a from the weathered pocket 118, thus making the system 100 ADA compliant and easier for a user to move the sliding door panel 104a from the closed position to the open position.

Handle and Cam Design

Human factors play a role in the design and/or shape of the handle(s) 122a,b. More specifically, understanding how a user will typically interact with the handle(s) 122a,b may allow the design to fit the average user as much as possible. In addition to limiting constraints of current handle designs, anthropometrics, a study of the measurements of the human body, may help determine an appropriate geometry of the door handle so that it may be gripped without causing excess effort or strain on the user. For patients with arthritis, for example, simple motions of the distal and interphalangeal joints of the hand can be the most difficult, in addition to the base of the thumb. This suggests that anything the user can hook their fingers around without pinching may provide a desirable design. The positioning of the handle 122a,b, the force required to slide the sliding door panel 104a, and the number of movements required to open the sliding door panel 104a may all be defined by ADA standards, which will constrain the dimensions and complexity of the final design. Such standards were created with the purpose of minimizing excess effort on the user.

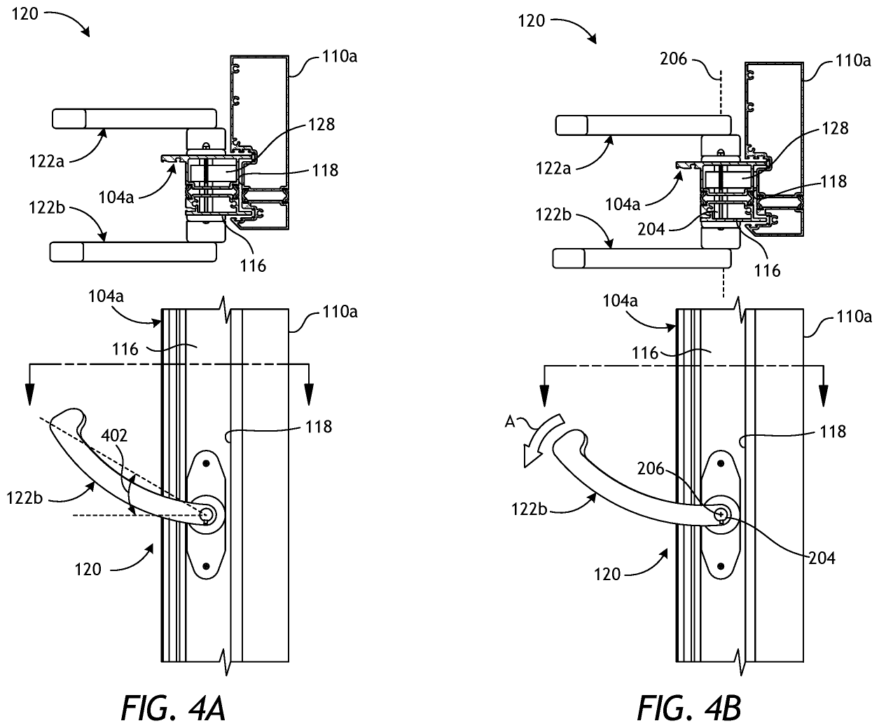

FIGS. 5A and 5B are schematic views of an example cam 500 that may be used in accordance with the principles of the present disclosure. The cam 500 may be the same as or similar to the cam 128 of FIGS. 1B, 2A-2B, 3A-3B, and 4A-4C, and may thus be used in the handle assembly 120 of FIGS. 1B, 2A-2B, 3A-3B, and 4A-4C. The cam 500 can exhibit a variety of dimensions and, as will be appreciated, the specific dimensions of the cam 500 may have engineering implications on user input force requirements. Example cam 500 dimensions include, but are not limited to, the length L_{cam} from the cam pivot point to the cam tip, and the radius r_{cam} of the circle whose center is the cam pivot point.

In setting these dimensions, it is important to understand the cam geometry and its relation to engineering requirements. The area with the most friction opposing movement of the handle assembly 120 FIGS. 1B, 2A-2B, 3A-3B, and 4A-4C may be the weathered pocket 118 FIGS. 1B, 2A-2B, and 4A-4C provided on the first side member 110a FIGS. 1B, 2A-2B, and 4A-4C, which may include weatherstripping or a weatherstrip. Consequently, the dimensions of the cam 500 may be related to the length (depth) of the weatherstrip, since once the door passes the weatherstrip, the main source of friction will be overcome and the door will meet ADA standards. When the cam 500 is in the extended position, as shown in FIG. 5B, the cam 500 pushes the door completely out of the doorjamb. The equation that describes this relationship is provided below, where L_{cam} is the length of the “major” axis of the cam 500 from pivot to tip, L_{weatherstrip} is the length the door must translate to be free of the weatherstrip, and r_{cam} is the radius of the circle whose center is it the cam's pivot point.

L_{cam}≥L_{weatherstrip}+r_{cam}

This inequality assumes the distance from the cam pivot point to the edge of the door is equal to r_{cam}. A larger distance from the pivot to the edge of the door would require a larger value for L_{cam}, to allow the door to translate the entire distance L_{weatherstrip}.

As the only fixed variable in the above inequality is L_{weatherstrip}, r_{cam} and L_{cam} are unrestrained and thus free variables. Assuming the smallest possible cam 500, the inequality becomes the following equation:

L_{cam}=L_{weatherstrip}+r_{cam}

As shown above, r_{cam} then remains the variable that must be set to dictate the length of the cam's major axis. In setting the value for r_{cam}, the factors that must be considered can include cost, space constraints, and user input force changes due to changes in r_{cam}. All these factors suggest that r_{cam} is optimized at its lowest possible value. From a cost perspective, as r_{cam} increases, the cam 500 becomes larger, requires more material to manufacture, and could be more expensive. Thus from a cost perspective a smaller value may be preferred. Moreover, smaller cam dimensions may prove advantageous in view of space constraints of the door. The value 2*r_{cam} or dᵣₐₘ must be small enough as not to exceed the frame width into which the cam 500 will be installed. In some applications, for example, this may be 2.5 inches on the outside of the door and 1.625 inches on the inside. This inequality is described below.

2*r_{cam}<=w_{frame}

r_{cam}<=0.81 inches

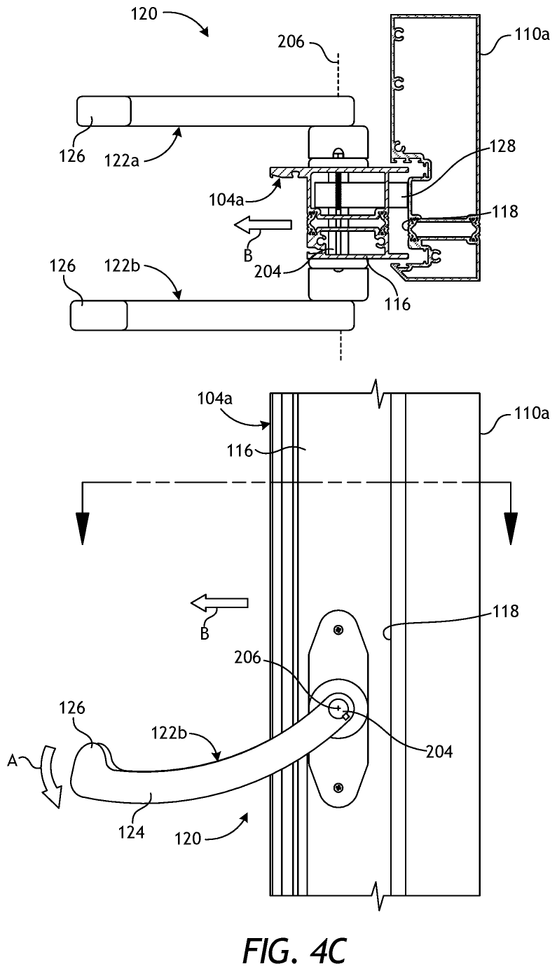

There may also be an engineering argument for a smaller value for r_{cam}, based on the frictional torque resisting motion that the doorjamb applies to the cam 500. There are two reaction torques present while the cam 500 is actuated that resist motion, based on a normal reaction force and a frictional force. These torques must be analyzed based on how r_{cam} affects their magnitudes. The normal force is the force with which the doorjamb pushes against the cam 500 in reaction to the applied force of the cam 500 on the doorjamb, and the frictional force is based on the rough surface between the cam 500 and the doorjamb. Normal torque is a vector cross product of moment arm in the y direction and normal force, and frictional torque is a vector cross product of moment arm in the x direction and frictional force. The normal force may be modeled at 12 lbf, and the frictional force may be modeled as the normal force of 12 lbf multiplied by the coefficient of friction between materials, which may be estimated conservatively (high). These equations are summarized below and FIG. 6 provides a free body diagram graphically depicting the calculation of the cam dimensions.

T_{jamb}=r_{y}×Fₙₒᵣₘₐₗ=r_{y}×12 [lb]\hat{l}

T_{friction}=rₓ×F_{friction}=rₓ×μ_{Fnormal}=rₓ×μ*12 [lbs]\hat{l}

Tₜₒₜₐₗ=T_{jamb}+T_{friction}=r_{y}×12 [lbs]\hat{l}+rₓ×μ*12 [lbs]\hat{l}

Tₜₒₜₐₗ is the total torque that friction and the doorjamb reaction force exert on the cam 500, which resist its rotation. The magnitude of this torque is what must be overcome to actuate the cam 500 and open the door, so ideally this value would be as low as possible. The value of r_{cam} does not directly influence the normal or frictional force components, which are set at 12 lbf and 12 lbf multiplied by the coefficient of kinetic friction, respectively. However, the moment arm in the x direction rₓ and the moment arm in the y direction r_{y} do have the ability to be influenced by the value of r_{cam}. These moment arms are also functions of the angle the cam 500 has rotated, which must also be considered.

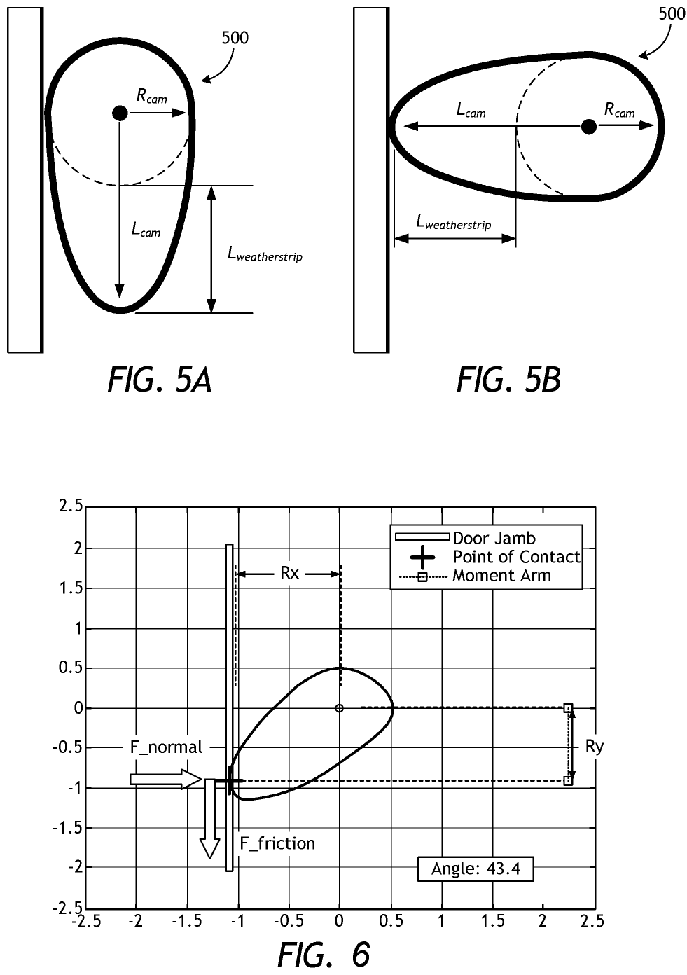

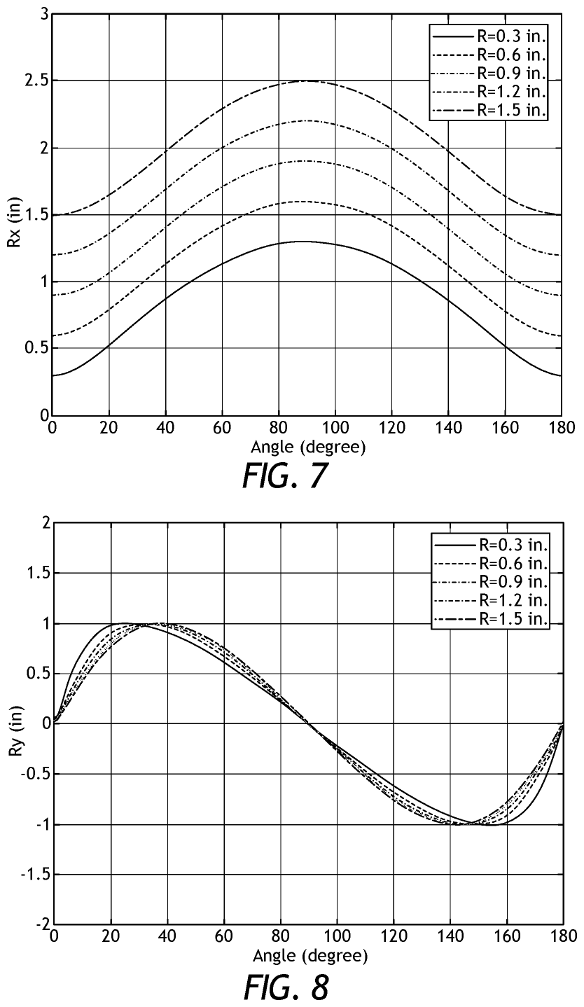

To understand the effect of r_{cam} on rₓ and r_{y}, FIG. 7 is a plot showing example moment arm (rₓ) as a function of angle of rotation for varying values of r_{cam} for an example cam, and FIG. 8 is a plot showing example moment arm (r_{y}) as a function of angle of rotation for varying values of r_{cam} for the example cam. In FIG. 7, the plot shows that the moment arm rₓ is clearly influenced by r_{cam}, where the rₓ function is linearly scaled by changes in r_{cam} while the overall shape of the curve is not affected. There is a positive correlation between r_{cam} and rₓ in that with increasing values of r_{cam}, rₓ also increases at a given angle by a value equal to the change in r_{cam}. With a longer moment arm comes a higher friction based resistance torque, requiring more user input force to overcome, justifying as small a value of r_{cam} as possible. In FIG. 8, plotted is r_{y} as a function of rotation angle at various values of r_{cam}. While slight variation occurs with varying values of r_{cam}, the curves are mostly identical, thus the resistance torque based on the r_{y} moment arm is largely unrelated to r_{cam} and instead is dictated much more so by the value of L_{weatherstrip}, which is already fixed.

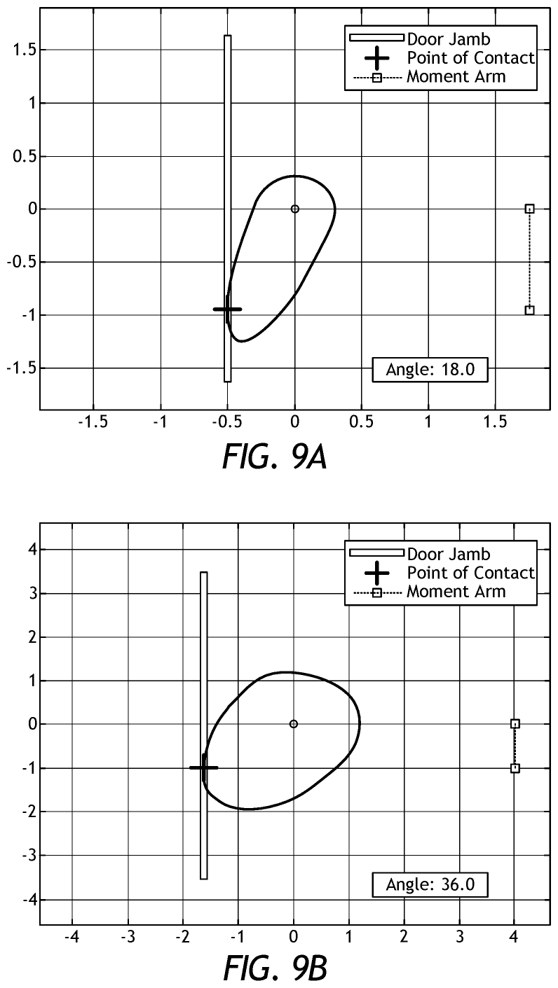

FIGS. 9A and 9B are plots of a 0.3 inch radius cam 900 and a 1.2 inch radius cam 902, respectively, at their maximum value of r_{y}. It can be seen that r_{y} peaks around one inch for these cams 900, 902 despite the radii being quite different between the two. To summarize these findings, the increase in rₓ with increasing r_{cam} values supports a small value for r_{cam}.

It is also important to understand the second objective in determining reaction torque, which is to determine the maximum force required to open the door. This force must be less than five lbs. to remain ADA compliant. In its most basic form, that relationship is described below,

T_{jamb}+T_{friction}=L_{handle}×Fᵢₙₚᵤₜ

where T_{jamb} is the resistance torque applied by the doorjamb, T_{friction} is the resistance torque applied by friction, L_{handle} is the moment arm at which the user applies an input force, and Fᵢₙₚᵤₜ is the force supplied by the user. Minimizing Fᵢₙₚᵤₜ involves maximizing L_{handle} and minimizing the T_{jamb}+T_{friction} term. The length of the handle is constrained geometrically at 8 inches, making L_{handle} 6 inches at its maximum (a resultant force applied at the center of one's hand would be about two inches from the endpoint of the handle if the edge of the hand and the edge of the handle were flush). In other words, the effective length of the handle is about 6 inches, whereas its full length is about 8 inches because the operator's hand is 2 inches from the axis. T_{jamb}+T_{friction} is set by the cam dimensions, with the most ideal value as small as possible. However, fatigue and stress analysis, though not completed, will set limits on the minimum possible size of the cam.

Next, the critical angle may be introduced, which can be defined as the angle at which maximum torque occurs for a given value of μ and r_{cam}. The critical angle comes into play based on its ability to influence the variables that influence the torque, namely rₓ, r_{y}, and μ.

The moment arms rₓ and r_{y} are a function of angle (and r_{cam}), thus there is a critical angle at which maximum torque occurs, which must be used to determine the maximum input force required, since the lowest possible input force must still overcome the highest possible reaction torque. The influence of r_{cam} in determining the length of moment arms has been discussed (negligible for r_{y} and a positive correlation for rₓ), but the influence of the angle at which the cam 900, 902 is rotated also plays a role. By plotting torque as a function of theta for given friction coefficients, the angle of maximum reaction torque occurs between 20 and 60 degrees (the cam 900, 902 rotates from zero to about 85 degrees, for reference). This critical angle changes with respect to the friction coefficient, because a higher coefficient of friction will contribute more to the total frictional moment when the cam 900, 902 is closer to 90 degrees (i.e., when the point of contact is rubbing more than pushing and the frictional moment arm rₓ is high). Regardless of the friction coefficient, it can be observed that the lowest torque required is seen at 0 degrees, when the cam 900, 902 is pointed downward, therefore this was selected as the starting position of the cam 900, 902 to make it easy to begin motion.

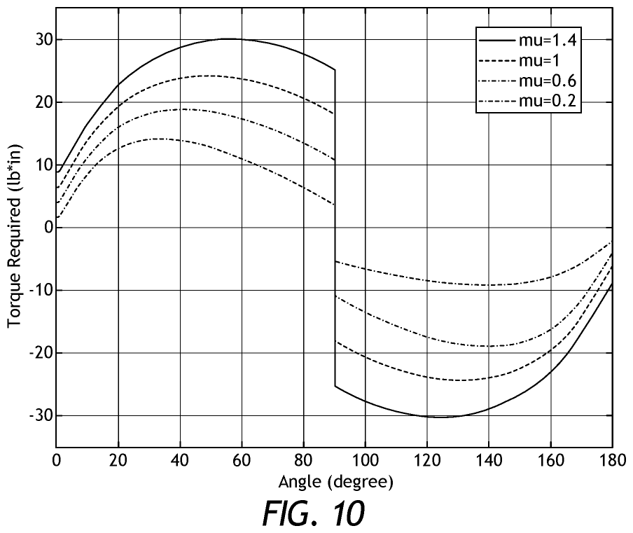

FIG. 10 is a plot depicting the torque required vs. cam angle for varying friction coefficients (“mu”). As is evident from the shape of the plot of FIG. 10, the friction force dominates the total torque required, due to μ being simulated as higher than 1.

Understanding this result requires analyzing the total torque equation. From that equation, the variables changing with theta are the moment arms. Namely, rₓ fluctuates from r_{cam} to L_{cam} as theta changes from 0 to 90 degrees, and r_{y} starts at zero, sharply increases to a value slightly less than L_{cam}, then decreases to zero as the handle is rotated from 0 to 90 degrees. Moment arms as a function of theta are shown previously in FIGS. 5 and 6. The tendency for rₓ to increase as r_{y} decreases maximizes the vector sum of the two moment arms close to 45 degrees, similarly to how the function sin(x)+cos(x) is maximized at 45 degrees. This assumes the reaction forces are nearly equivalent (just as the sine and cosine coefficients must be equal to one for a max value at 45 degrees), but a difference in the force magnitudes is actually the case, which adjusts the torque components, causing the higher frictional torque to influence the angle of maximum torque more so than the reaction force torque.

With numeric values for coefficient of friction and r_{cam} chosen at 1.4 and 0.5 inches, respectively, the angle of maximum torque occurs at about 55 degrees. At 55 degrees of rotation, rₓ=1.35 inches and r_{y}=0.74 inches, and the maximum torque can be evaluated to equal 31.56 lb*in. Setting this value equal to the applied torque that must overcome the resistance to rotation, the force required by a six inch moment arm is 5.26 lbs, slightly over the requirement of five lbs. This provides confidence that the design can work, though optimizing material selection to reduce the kinetic coefficient of friction may be another route taken to bring the maximum required force input to below 5 lbs. In at least one embodiment, for a 5 lb force requirement the length of the handle L_{handle} may be 6.31 inches or longer.

The example 6-inch length of the handle may be based on the typical length of wing-type door handles and the ergonomics of the human hand. It is also known that the longer the handle, the more torque the user will achieve with less force. Additionally, the length of the handle is constrained within the distance between the stationary and active glass panels of the door when the door is fully open: a length of about 8 inches.

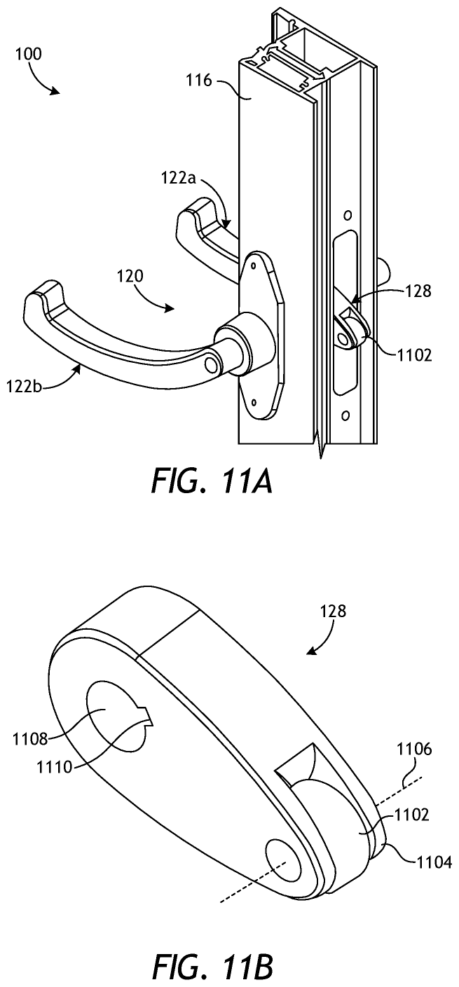

FIG. 11A is a right isometric view of a portion of the system 100 of FIGS. 1A-1B, according to one or more additional embodiments. As illustrated, the handle assembly 120 is installed in the vertical stile 116, and the handles 122a,b are depicted in the second position. As depicted, as the handles 122a,b reach the second position, the cam 128 correspondingly rotates and reaches the extended position. In the illustrated embodiment, the cam 128 includes a roller element 1102 rotatably mounted to the cam 128. As the cam 128 rotates to the extended position, the roller element 1102 progressively engages and rolls against the inner surface of the weathered pocket 118 (FIGS. 1A-1B and 2A-2B). In its rotation, the cam 128 applies a camming force that disengages the stile 116 from the weathered pocket 118 and drives the sliding door panel 104a (FIGS. 1A-1B and 2A-2B) away from the first side member 110a (FIGS. 1A-1B and 2A-2B) and to the open position.

FIG. 11B is an enlarged isometric view of the cam 128 depicted in FIG. 11A, according to one or more embodiments. As illustrated, the cam 128 includes the roller element 1102 mounted to the cam 128 at a distal clevis 1104 defined or otherwise provided by the cam 128. The roller element 1102 may be rotatable about a central axis 1106 during operation. The roller element 1102 may be made of a variety of rigid and semi-rigid materials including, but not limited to, a metal, a plastic, a ceramic, a rubber, a composite material, or any combination thereof.

In some embodiments, as illustrated, the cam 128 defines an aperture 1108 through which the handle spindle 204 (FIGS. 2A-2B and 3A-3B) may extend. As indicated above, the cam 128 may be coupled to the handle spindle 204 such that rotation of the handle spindle 204 by rotating one or both of the handles 122a,b (FIG. 11A) correspondingly rotates the cam 128 in the same angular direction. In the illustrated embodiment, the cam 128 defines a keyway 1110 matable with a key provided on the handle spindle 204. In other embodiments, however, the keyway may alternatively be provided on the handle spindle 204, and the key may be defined by the cam 128, without departing from the scope of the disclosure.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A sliding door system, comprising:
a stationary door frame;
a sliding door panel installed in the stationary door frame and movable between a closed position and an open position;
a handle assembly coupled to the sliding door panel and including:
a handle spindle extending into a vertical stile of the sliding door panel;
a cam coupled to the handle spindle within the vertical stile and movable between a stowed position and an extended position; and
a handle coupled to the handle spindle and rotatable about a pivot axis extending through the handle spindle between a first position and a second position,
wherein rotating the handle from the first position to the second position causes the cam to move from the stowed position to the extended position and protrude from the vertical stile into engagement with the stationary door frame, whereby the sliding door frame is forced away from the stationary door frame from the closed position to the open position.

2. The sliding door system of claim 1, further comprising a weathered pocket provided on a side member of the stationary door frame, the vertical stile being partially receivable within the weathered pocket when the sliding door panel is in the closed position, and
wherein moving the cam to the extended position engages the cam on the side member and thereby disengages the vertical stile from the weathered pocket.

3. The sliding door system of claim 2, wherein 5 lbs. of force or less is required to be applied to the handle to disengage the vertical stile from the weathered pocket.

4. The sliding door system of claim 1, wherein the handle in the first position is oriented at an angle between horizontal and vertical.

5. The sliding door system of claim 1, wherein the handle has an arcuate body.

6. The sliding door system of claim 1, further comprising an upwardly-protruding lip provided at a distal end of the handle.

7. The sliding door system of claim 1, wherein the handle assembly is made of a rigid material selected from the group consisting of a metal, a high-strength polymer, a composite material, glass, and any combination thereof.

8. The sliding door system of claim 1, wherein the handle spindle is supported by one or more low-friction bearings.

9. The sliding door system of claim 1, further comprising a helical coil spring operatively coupled to the handle spindle and operable to move the handle back to the first position when a user input force is removed from the handle.

10. The sliding door system of claim 1, wherein the handle comprises a first handle mounted on a first side of the vertical stile and coupled to a first end of the handle spindle, the handle assembly further comprising:
a second handle mounted on a second side of the vertical stile and coupled to a second end of the handle spindle, the second handle being rotatable about the pivot axis between a first position and a second position,
wherein rotating the second handle from the first position to the second position causes the cam to move from the stowed position to the extended position.

11. A method of operating a sliding door system, comprising:
placing a load on a handle of handle assembly coupled to a sliding door panel installed in a stationary door frame, the handle assembly including:
a handle spindle extending into a vertical stile of the sliding door panel, the handle being coupled to the handle spindle; and
a cam coupled to the handle spindle within the vertical stile and movable between a stowed position and an extended position;
pivoting the handle about a pivot axis extending through the handle spindle from a first position to a second position and thereby moving the cam to the extended position and into engagement with the stationary door frame; and
forcing the sliding door frame away from the stationary door frame with the cam and thereby moving the sliding door frame from the closed position to the open position.

12. The method of claim 11, wherein a weathered pocket is provided on a side member of the stationary door frame, the method further comprising:
partially receiving the vertical stile within the weathered pocket when the sliding door panel is in the closed position;
rotating the cam toward the extended position and thereby engaging the cam on the side member; and
disengaging the vertical stile from the weathered pocket as the cam moves to the extended position.

13. The method of claim 12, further comprising applying no more than 5 lbs. of force to the handle to disengage the vertical stile from the weathered pocket.

14. The method of claim 11, wherein the handle spindle is supported by one or more low-friction bearings, and a helical coil spring is operatively coupled to the handle spindle, the method further comprising:
building spring force in the helical coil spring as the handle moves from the first position to the second position;
removing the load on the handle;
releasing the spring force in the helical coil spring and thereby moving the handle from the second position to the first position; and
moving the cam back to the stowed position as the handle moves from the second position to the first position.

15. The method of claim 11, wherein the handle comprises a first handle mounted on a first side of the vertical stile and coupled to a first end of the handle spindle, the handle assembly further including a second handle mounted on a second side of the vertical stile and coupled to a second end of the handle spindle, the method further comprising
pivoting the second handle about the a pivot axis between a first position and a second position and thereby moving the cam to the extended position and into engagement with the stationary door frame; and
forcing the sliding door frame away from the stationary door frame with the cam and thereby moving the sliding door frame from the closed position to the open position.

16. A handle assembly for a sliding door panel of a sliding door system, comprising:
a handle spindle extendable into a vertical stile of the sliding door panel;
a cam coupled to the handle spindle and configured to be positioned within the vertical stile and movable between a stowed position and an extended position; and
a handle coupled to the handle spindle and rotatable about a pivot axis extending through the handle spindle between a first position and a second position,
wherein rotating the handle from the first position to the second position causes the cam to move from the stowed position to the extended position and protrude from the vertical stile.

17. The handle assembly of claim 16, wherein the handle in the first position is oriented at an angle between horizontal and vertical.

18. The handle assembly of claim 16, wherein the handle has an arcuate body and an upwardly-protruding lip provided at a distal end of the handle.

19. The handle assembly of claim 16, further comprising a roller element rotatably mounted to the cam.

20. The handle assembly of claim 16, further comprising at least one of:
one or more low-friction bearings that supports the handle spindle; and
a helical coil spring operatively coupled to the handle spindle and operable to move the handle back to the first position when a user input force is removed from the handle.
